(19) United States
(12) Patent Application Publication
(10) Pub. No.: US 2005/0087349 A1
(43) Pub. Date: Apr. 28, 2005

(54) Wedge system for sprinkler

(76) Inventors: J. Craig Corbett, Mountain View, WY (US); Natalie H. Corbett, Mountain View, WY (US); Rene M. Roderer, Wellsville, UT (US)

Correspondence Address: Dean P. Edmundson, P.O. Box 179, Burton, TX, 77835, US

(21) Appl. No.: 10/956,271

(22) Filed: Oct. 1, 2004

Related U.S. Application Data
(60) Provisional application No. 60/510,421, filed on Oct. 10, 2003.

(51) Int. Cl. B05D 1/00; A01B 45/00

(52) U.S. Cl. 172/22; 239/201

(57) ABSTRACT

A wedge system for stabilizing a sprinkler which has been installed in the ground in close proximity to a sidewalk, curb, etc. The wedge is positioned between the sprinkler and the sidewalk, curb, etc. and is held there by frictional engagement to prevent the sprinkler from drifting toward the sidewalk, curb, etc.

### CROSS-REFERENCE TO RELATED APPLICATIONS

This application is based upon, and claims priority from, Provisional Application No. 60/510,421, filed Oct. 10, 2003. This application is also related to application Ser. No. 10/626,910, filed Jul. 25, 2003; application Ser. No. 10/674,222, filed Sep. 29, 2003; and application Ser. No. 696,931, filed Oct. 30, 2003. This application is also related generally to U.S. Pat. No. 6,575,380.

### FIELD OF THE INVENTION

This invention relates to sprinkler systems commonly used for sprinkling lawns or other landscaped areas. More particularly, this invention relates to techniques for stabilizing sprinklers in the ground to prevent them from drifting toward a sidewalk or curb, etc.

### BACKGROUND OF THE PRIOR ART

Typical sprinkler systems used for lawns and other landscaped areas include water supply lines which are placed below ground and extend from a main supply pipe to each sprinkler head. The sprinkler head extends upwardly to the upper surface of the ground. Typical sprinkler heads are of the “pop-up” style which extend upwardly above the grass when pressure is applied to the water in the supply line, and then the sprinkler head retracts when it is no longer in use. The top of the sprinkler head remains exposed at ground level.

In some installations, the sprinkler head is connected to the water supply pipe with a flexible pipe. Although this enables the installer to more easily position the sprinkler head in a desired place, the flexible pipe provides little, if any, support to the sprinkler head (either lateral or vertical support). As a result, when soil is filled in around the sprinkler head, the sprinkler head can tilt or drift to one side or the other, and the sprinkler head can also sink downwardly. When the sprinkler head is too close to a sidewalk, curb or other such object, the spinning metal blade of an edger can irreparably damage any sprinkler head which is too close to sidewalk, curb, etc. Then the sprinkler head must be replaced, at considerable time and expense.

U.S. Pat. No. 5,102,048 (Bohnhoff) describes an irrigation head support which is a circular mat with a plurality of concentric circular ribs connected by a plurality of radially extending ribs. There is an opening in the center of the mat for receiving an irrigation head. The mat also includes a plurality of upwardly extending rings which are spaced around the outer portion of the mat. The upper surface of such rings is to be placed at ground level when the mat and the irrigation head are installed (e.g. on a golf course). The purpose of the guard is said to be for protecting an irrigation head from vehicle tires and for preventing erosion of the soil surrounding the head. The circular mat was not designed or intended for use in connection with obtaining the proper spacing of sprinkler heads in lawns from sidewalks, curbs, etc. where edgers are used. Further, the circular mat was not designed for providing support to a sprinkler head attached to a flexible pipe.

U.S. Pat. No. 5,678,353 (Tsao et al.) describes a grass guard for preventing growth of any vegetation around a perimeter of an object (e.g. a sprinkler head). The grass guard is composed of two layers. The top layer is a plastic sheet simulating grass, and the bottom layer is made of heavy grit bonded into a uniform body with a polymer. The grass guard is shown as a circular mat which has a central opening for a sprinkler head to fit through. The grass guard is intended for use around existing sprinkler heads. Where a sprinkler head is already located adjacent to a sidewalk, for example, one side of the grass guard can be cut away. There is no description in the patent regarding use of the grass guard during installation of a sprinkler head to maintain proper position of the sprinkler head, and even if the grass guard was used, a lawn edger would still hit it while edging. Further, the patent does not describe use of the mat to provide lateral and vertical support to a sprinkler head connected to a flexible pipe.

U.S. Pat. No. 6,186,416 (Jones) describes a trim ring for use around a lawn sprinkler to discourage grass growth around it and to protect the sprinkler by indicating its location. The trim ring includes two complementary plates, each having a notch which, when assembled, forms a central aperture fitting around a sprinkler body. The overlapped plates are then secured to each other by screws. The patent does not describe use of the trim ring for positioning sprinkler heads during installation next to a sidewalk or curb, etc. Further, the patent does not refer to providing lateral or vertical support to a sprinkler head.

U.S. Pat. No. 4,146,181 (Soos) describes a guard ring for a lawn sprinkler. The guard ring includes a central sleeve for surrounding the upper portion of the sprinkler head, and a frustoconical skirt extends outwardly and downwardly from the upper edge of the sleeve. A plurality of stabilizing fins extends downwardly and outwardly from the periphery of the skirt. The guard ring is for protecting the sprinkler head from lawn mowers which drive over the sprinklers. The patent does not describe use of the guard ring for positioning of sprinkler heads adjacent to sidewalks, curbs, etc. Further, the patent does not describe providing lateral and vertical support to a sprinkler head connected to a flexible pipe.

U.S. Design Pat. No. D410,731 (Bowman et al.) shows a sprinkler head guard which appears to be a circular disk with an off-set opening extending through it. The apparent purpose of the guard is to protect the sprinkler head from the activity of conventional lawn mowers.

There has not heretofore been provided a system for effectively preventing a previously installed sprinkler head from tilting or drifting toward a sidewalk, curb, or other rigid boundary material in a landscaped area.

### SUMMARY OF THE INVENTION

In accordance with the present invention there is provided a wedge system for stabilizing a sprinkler in the ground to prevent the sprinkler from drifting toward a sidewalk, curb, etc. The wedge system is positioned between the sprinkler and the edge of a sidewalk or curb, etc. and assures that the sprinkler in the ground will remain a sufficient distance away from a sidewalk, curb, etc. to allow the blade of an edger to trim grass along the edge of the sidewalk or curb without hitting and damaging the sprinkler. Frictional forces between the wedge, the sprinkler and the sidewalk or curb are sufficient to hold the wedge in place.

In one embodiment, the wedge system comprises a molded body member with a tapered lower end, an indented or recessed side surface for contacting the side wall of a sprinkler body, and a generally flat or planar top surface. Preferably the wedge also includes side edges which are angled away from the rear surface of the body.

Use of the wedge system is beneficial for stabilizing a previously installed sprinkler which has drifted too close to a sidewalk, curb, etc. This will protect the sprinkler from being damaged when an edger with a metal blade is used to trim grass along the sidewalk or curb. It is preferred that the top or upper portion of the wedge body be positioned at least about 1.5 to 3 inches below the rim of the sprinkler head so that the wedge is not contacted by a conventional lawn edger which is used to cut grass along a sidewalk, curb, etc.

The shape and size of the wedge may vary. Preferably the lower end of the wedge is tapered and the upper end is flat or planar. The thickness and the width of the wedge may also vary. The wedge does not interfere with conventional lawn edging operations.

Other advantages and features of the system of this invention will be apparent from the following detailed description and accompanying drawings.

### BRIEF DESCRIPTION OF THE DRAWINGS

The invention is described in more detail hereinafter with reference to the accompanying drawings wherein:

FIG. 1 is an elevational view showing an existing sprinkler which has drifted or tilted toward a sidewalk or curb, etc.;

FIG. 2 is an elevational view of the sprinkler of FIG. 1 after removing a portion of the sod along one side of the sprinkler;

FIGS. 3 and 4 are side elevational views illustrating the manner of insertion of a wedge of the invention between a sprinkler and the sidewalk or curb;

FIGS. 5A, B, and C are top plan views showing the wedge being used in different situations;

FIG. 6 is a front perspective view of another embodiment of wedge of the invention;

FIG. 7 is a rear perspective view of the wedge of FIG. 6;

FIG. 8 is a rear elevational view of the wedge of FIG. 6;

FIG. 9 is a side elevational view of the wedge of FIG. 6;

FIG. 10 is a bottom plan view of the wedge of FIG. 6;

FIGS. 11 and 12 illustrate use of a tool for installing a wedge between a sprinkler and the edge of a sidewalk or curb;

FIG. 13 is a top plan view of a sprinkler in a lawn next to a sidewalk or curb;

FIG. 14 is a top plan view of the sprinkler, wedge and installation tool of FIG. 12;

FIG. 15 is a side elevational view of a turf plug cutter which is useful in this invention; and

FIG. 16 is an isometric view of one embodiment of a wedge installation tool useful in this invention.

### DETAILED DESCRIPTION OF THE INVENTION

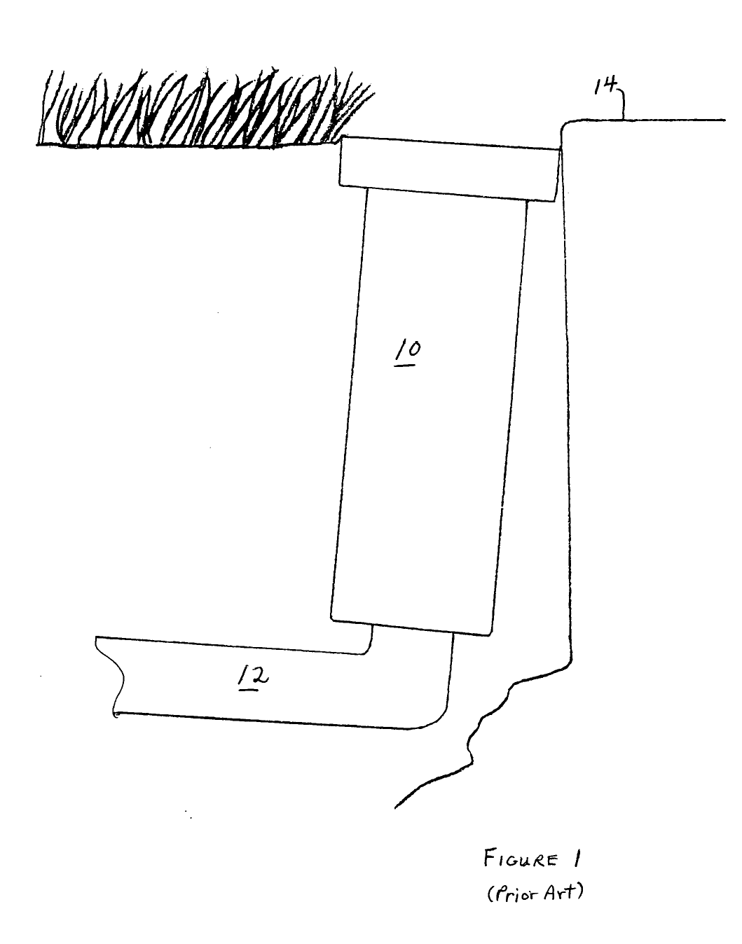

FIG. 1 shows a conventional sprinkler head 10 attached at its lower end to a flexible hose or pipe 12 which supplies water to the sprinkler. The sprinkler head is intended to be positioned in close proximity to a sidewalk, curb, etc. 14. As will be readily noted from the drawing, the sprinkler has tilted or drifted toward the sidewalk, curb, etc. There is insufficient room between the sprinkler and the sidewalk to enable a conventional edger with metal blade to be used between the sprinkler and the sidewalk without causing damage to the sprinkler. Drifting of the sprinkler can occur due to insufficient packing of the soil around the sprinkler during installation, or erosion of the soil over a period of time, or sometimes it could be caused by the installer simply placing the sprinkler too close to the edge of the sidewalk.

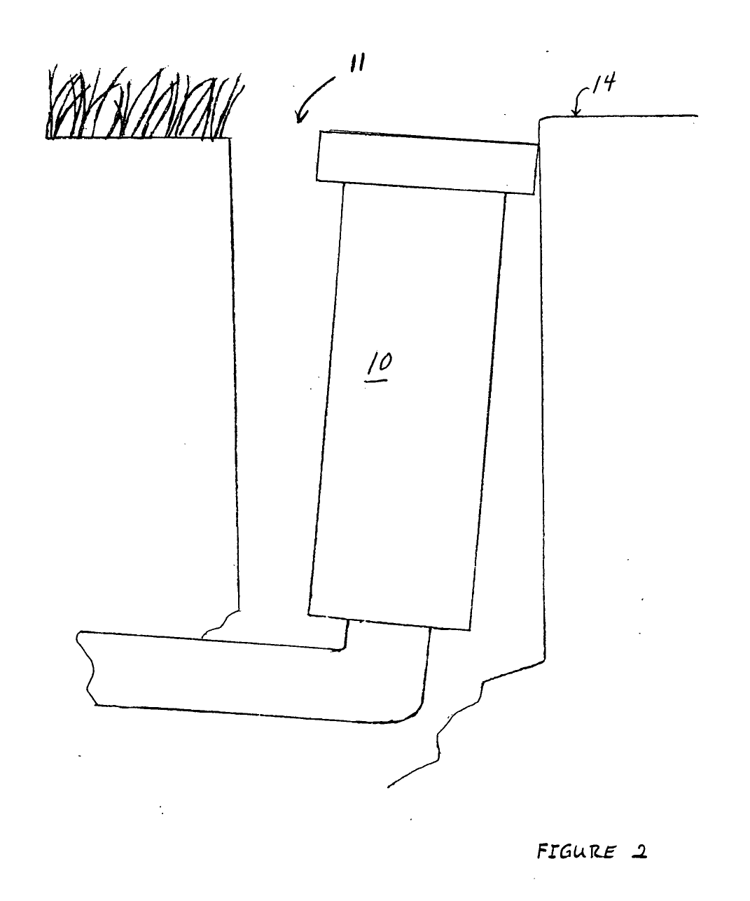

FIG. 2 illustrates a preferred step of removing a portion of the sod and soil from the back side of the sprinkler 10. This is to provide space (e.g. a cavity 11) for the sprinkler body to be moved to when the wedge is inserted.

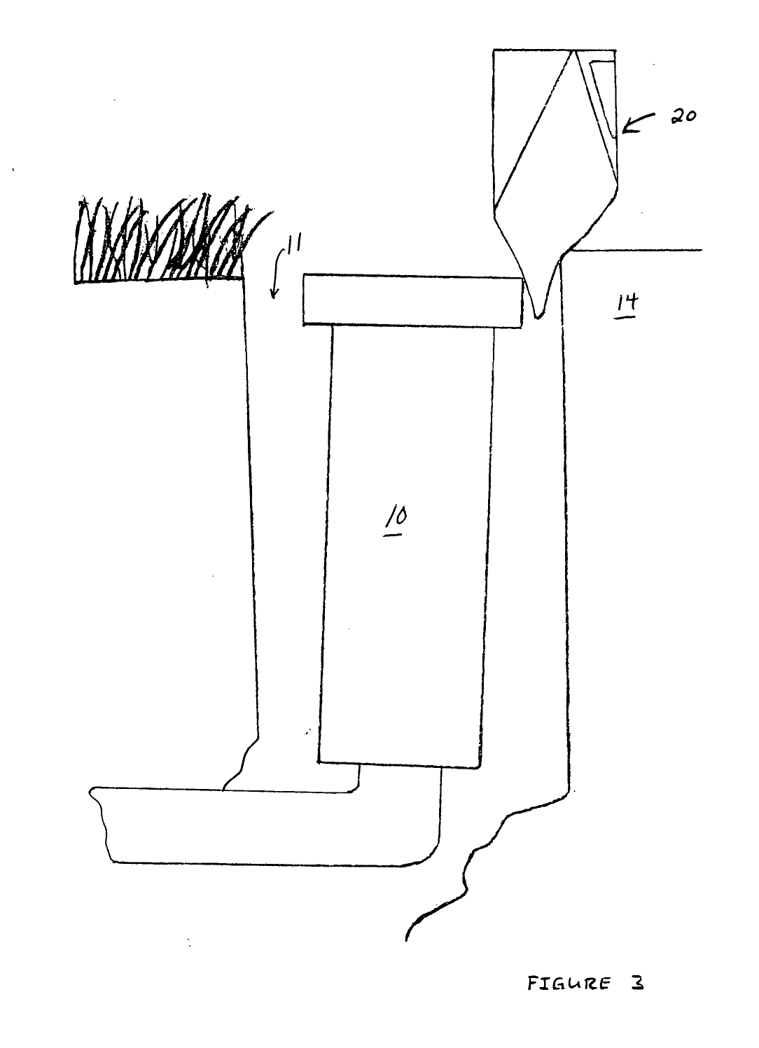

FIG. 3 shows the preferred wedge 20 being inserted between the inner edge of the sidewalk and the sprinkler body. The wedge thereby forces the sprinkler 10 away from the inner edge of the sidewalk 14 and into the cavity 11 on the back side of the sprinkler. Because one side edge of the wedge 20 is recessed, the cylindrical body of the sprinkler fits into the recess, as shown in FIG. 4. The outward bias of the sprinkler against the wedge keeps the wedge in frictional engagement between the sprinkler body and the sidewalk. The presence of the wedge assures that the sprinkler body will remain a fixed distance (e.g. 0.5 to 1 inch) from the edge of the sidewalk to enable the blade of an edger to pass between the sprinkler and the sidewalk without damaging the sprinkler.

In FIGS. 5A, B and C there are shown top views of the wedge 20 being used to hold a sprinkler 10 away from sidewalks, curbs, etc. In FIG. 5A there is shown wedge 20 with a curved recess 21 on one side and flat or planar surfaces 24 on the opposite side. Additionally, there are surfaces 22 and 23 which are angled away from surfaces 24 (e.g. at 45 degrees). The presence of these angled surfaces 22 and 23 is beneficial when the wedge is used to stabilize a sprinkler in other situations. For example, in FIG. 5B the sprinkler 10 is located in a corner where sidewalk 14 intersects sidewalk 15 at a right angle. The angled surfaces 22 and 23 of the wedge are able to fit flat against the edges of these two sidewalks. In FIG. 5C the sprinkler is located in a corner where sidewalk 14 intersects sidewalk 16 at an angle of about 135 degrees. In this situation, surfaces 24 rest against sidewalk 14 and surface 23 rests against sidewalk 16, as shown. Of course, the wedge can be used in other situations even where the angles between intersecting sidewalks is other than as shown and illustrated here.

The presence of notch 20A in the front edge of the wedge is useful for accommodating a tool for urging the wedge into the space between the sidewalk and the sprinkler during installation of the wedge. For example, an elongated rod may be used which fits into the notch and which has a cross member located upwardly from the lower end of the rod to engage the top surface of the wedge.

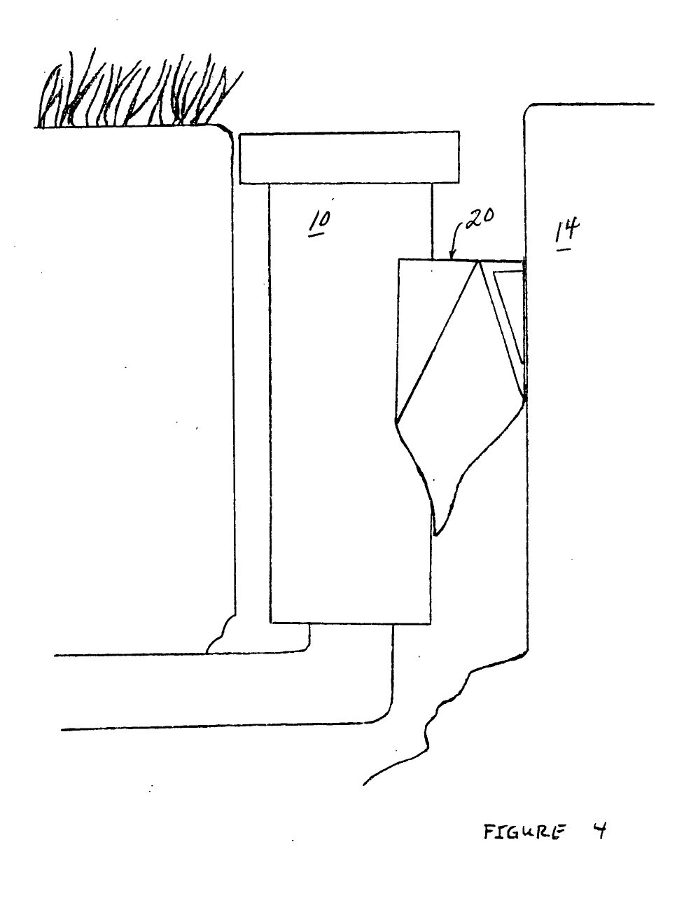

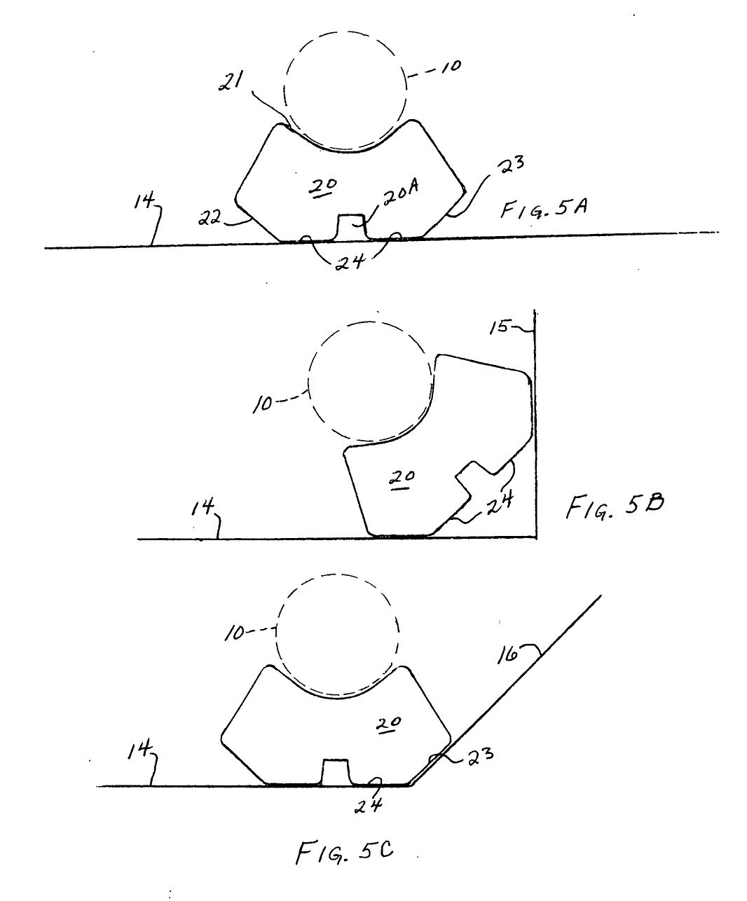

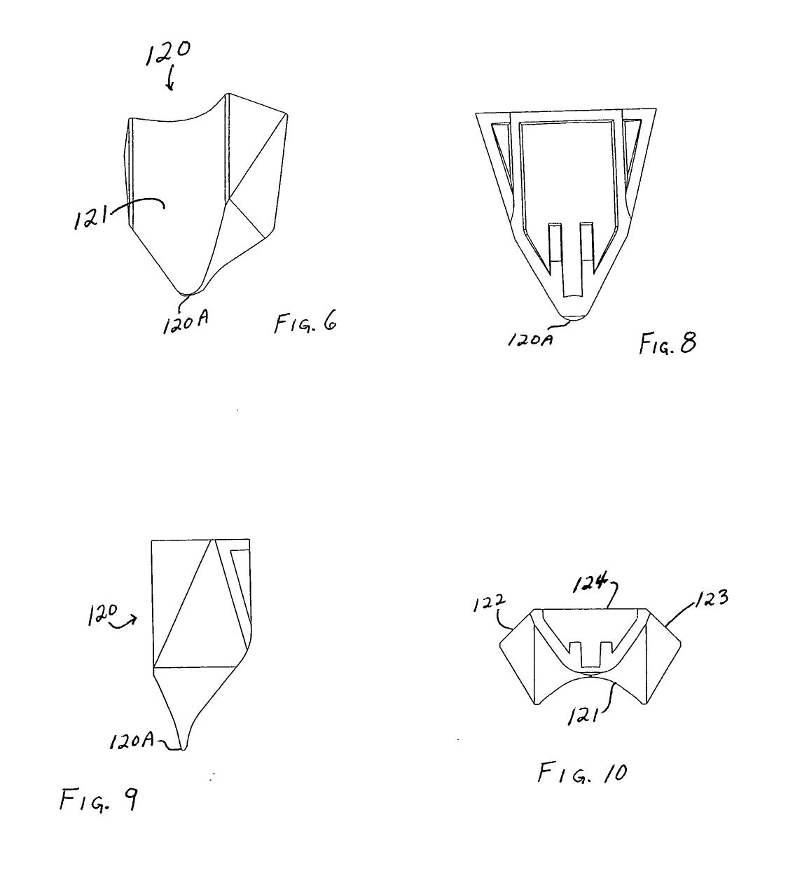

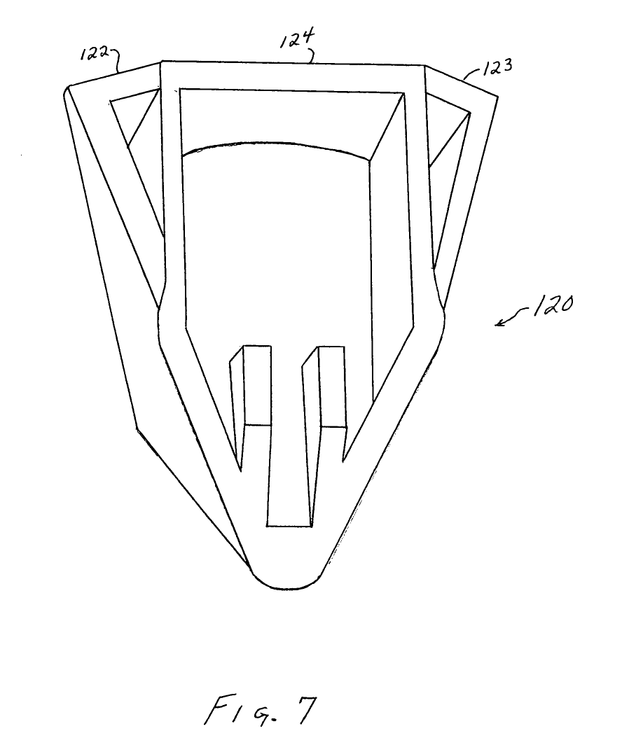

FIGS. 6-9 show another embodiment of the wedge 120 of the invention. The wedge preferably includes a curved or recessed portion 121 along one face, and it preferably also includes a tapered lower end 120A. The upper surface of the wedge is preferably flat or planar. The wedge also includes a generally straight edge 124 which is opposite the curved face 121. Edges 122 and 123 are each angled away from edge 124 at an angle of about 45 degrees.

The wedge of this invention can be composed of any desired material. Normally it is composed of a plastic material because of economics and because it is light in weight. Various conventional plastics are suitable (e.g. polystyrene, nylon, PVC, acrylic, carbonate, etc.). Metal, wood, ceramic, fiberglass or composite materials could also be used. The sizing and styling of the wedge could also vary and it can be made to accommodate any diameter of sprinkler head.

FIGS. 11 and 12 illustrate another embodiment of wedge 130 which is useful in this invention. The wedge has a tapered lower end and includes spaced-apart side portions or rails 131. The upper surface 130A of the wedge is generally perpendicular to the side portions. The inner face of the wedge is recessed (preferably it is a concave surface) so as to fit against the sidewall of a cylindrical sprinkler 10. A tool 140 which is useful in installing the wedge comprises an elongated shaft 141. At the lower end of the shaft there is a key portion 144 which slides between the side portions or rails 131 of the wedge. Plate 143 is secured to the shaft 141 (preferably perpendicular to the longitudinal axis of shaft 141) and is wider than the space between side portions 131 so that downward pressure on shaft 141 causes the wedge to be forced downwardly below the surface of the lawn or sod. Arm 142 projects outwardly from shaft 141 and serves as a depth gauge. When the tool and wedge are pushed downwardly alongside the sprinkler, the arm 142 eventually contacts the sidewalk or curb 14 and prevents further downward movement of the wedge. The spacing between the underside of the plate 143 and arm 142 determines the depth of the upper surface of the wedge (generally 1.5 to 3 inches).

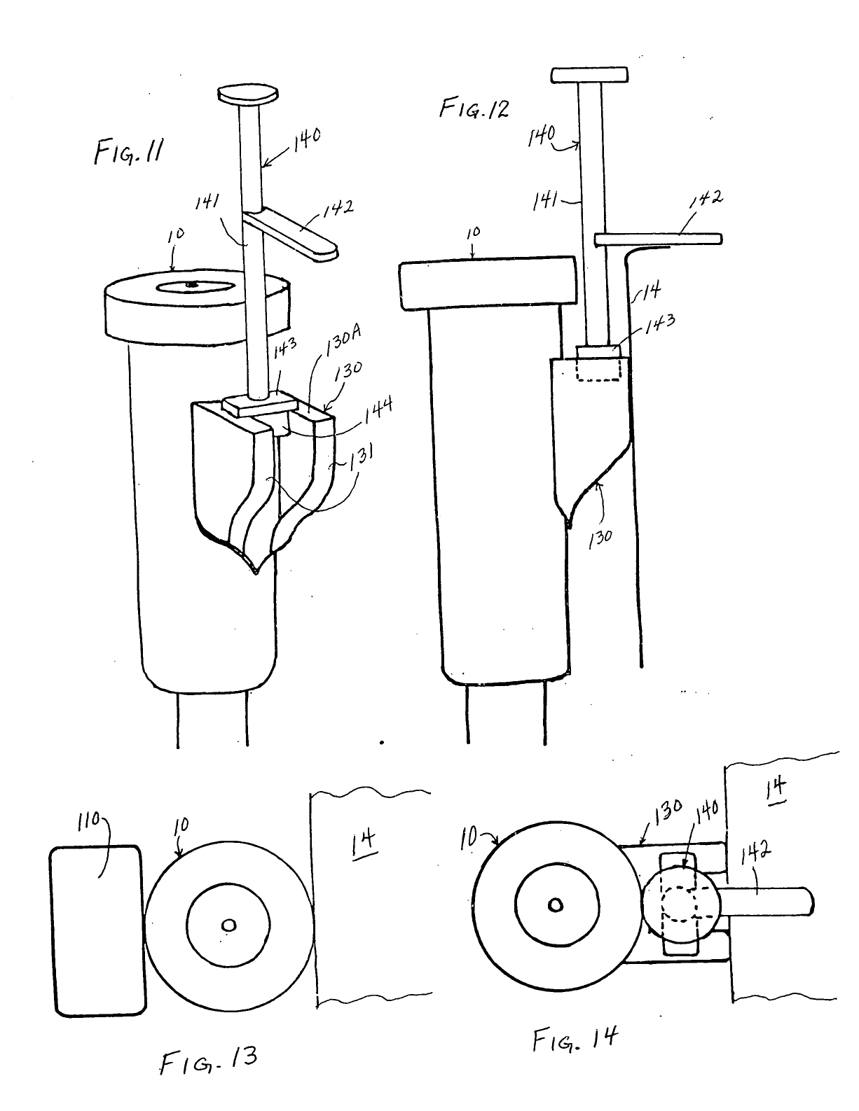

FIG. 13 is a top plan view of a sprinkler 10 adjacent to the edge of sidewalk 14. A section of turf or sod immediately behind the sprinkler (away from the sidewalk) has been removed, leaving cavity 110 in the sod. FIG. 14 is a top plan view showing the wedge installed between the sprinkler and the sidewalk, using the tool 140. The wedge has urged the sprinkler 10 away from the sidewalk and into the area where the cavity 110 in the sod was made.

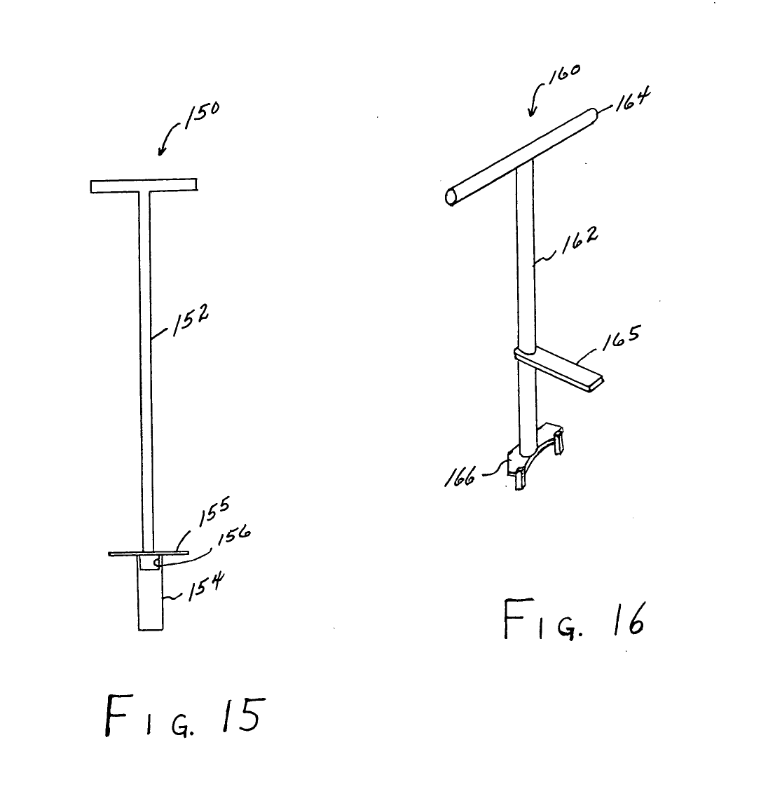

FIG. 15 is a side elevational view of a turf plug cutter tool 150 which is useful in removing a section or plug of sod from one side of an existing sprinkler (opposite the edge of the sidewalk or curb, etc.). Removal of a plug of sod (grass and soil) adjacent a sprinkler provides a space for the sprinkler to move into when a wedge is inserted between the sprinkler and the sidewalk or curb. The tool includes an elongated handle 152 with a hollow cutting tube 154 on its lower end. One or more outwardly projecting flanges 155 may be included near the lower end for the user to stand on in order to force the cutting tube into the ground to cut the sod. The flanges also serve as a depth gauge for limiting the depth the tube can be forced into the ground. As the lower end of the tube is forced into the ground, the cutting tube cuts a section of the sod in the shape of the cutting tube (which may have a square, rectangular, circular, oval, etc. cross-sectional shape). The cutting tube may include an opening 156 in its side wall just below the flanges 155 to enable a cut turf plug to exit through the side of the tube 154.

FIG. 16 shows another embodiment of an installation tool 160 which may be used to insert a wedge between a sprinkler and a sidewalk or curb. The tool includes an elongated shaft 162 with a handle 164 on the upper end, a depth gauge 165 extending perpendicularly from the shaft, and a foot member 166. The foot member can be placed on top of a wedge to be inserted between an existing sprinkler and the edge of a sidewalk or curb. As downward pressure is applied to the tool, the wedge is forced downwardly until the depth gauge contacts the sidewalk or curb.

Other variants of the invention are possible.

1. A wedge system for laterally supporting a sprinkler head in the ground and preventing the sprinkler head from drifting too close to a sidewalk or curb, the system comprising a body member having an outer peripheral portion and an inner portion; wherein said inner portion of said body member includes a recessed face for placement adjacent to said sprinkler head; wherein said wedge system provides lateral support to said sprinkler head when said body member is positioned between said sprinkler head and said sidewalk or curb.

2. A wedge system in accordance with claim 1, wherein said recessed face is a concave surface.

3. A wedge system in accordance with claim 2, wherein said peripheral portion of said body includes three edges which are angled relative to each other.

4. A wedge system in accordance with claim 1, wherein said body is tapered at its lower end.

5. A wedge system in accordance with claim 1, wherein said outer peripheral portion extends outwardly a predetermined distance so as to enable said sprinkler head to be positioned adjacent to a sidewalk or curb with a spacing at least equal to said predetermined distance.

6. A method for preventing a sprinkler which has been installed in the ground from drifting toward a sidewalk or curb, the method comprising inserting a wedge between said sprinkler and said sidewalk or curb; wherein said wedge comprises a body having an outer peripheral portion and an inner portion, wherein said inner portion is positioned adjacent said sprinkler and said outer peripheral portion is positioned adjacent said sidewalk or curb.

7. A method in accordance with claim 6, comprising the further step of inserting said wedge by pushing downwardly against said wedge with a tool including a depth gauge.

8. A turf plug cutting tool comprising an elongated handle having a tubular cutting tube at its lower end and means for limiting the depth to which said tool may be forced into the ground.
